(19) United States
(12) Patent Application Publication
(10) Pub. No.: US 2009/0295747 A1
(43) Pub. Date: Dec. 3, 2009

(54) Touch-sensitive liquid crystal display device with built-in touch mechanism

(75) Inventors: Yu-Lin Hsieh, Miao-Li (TW); Chao-Yi Hung, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/455,073

(22) Filed: May 28, 2009

(30) Foreign Application Priority Data
May 30, 2008 (TW) 97120032

(51) Int. Cl. G06F 3/041

(52) U.S. Cl. 345/173

(57) ABSTRACT

A touch-sensitive liquid crystal display (LCD) device includes a first substrate, a second substrate opposite to the first substrate, and a liquid crystal layer sandwiched between the first and second substrates. A first sensing line, a second sensing line, a reference capacitor, and a variable capacitor connected with the reference capacitor in series are arranged on the first substrate. A node between the reference capacitor and the variable capacitor is couple to the first and second sensing lines. A capacitance of the variable capacitor is changeable when acted upon an external pressure.

### TECHNICAL FIELD

The present disclosure relates to touch-sensitive liquid crystal display (LCD) devices.

### DESCRIPTION OF RELATED ART

The LCD has been used as an image display means in a wide variety of applications. A touch panel for inputting signals via a display screen of an LCD allows a user to select desired information while viewing images without depending on other separate inputting devices such as a keyboard, a mouse or a remote controller. The touch panel thus meets many demands for user-friendly, simplified and convenient operation of an LCD.

State-of-the-art types of touch panels include resistive, capacitive, acoustic, and infrared (IR) touch panels, among others. One typical touch panel has a rectangular transparent panel, and is stacked on and integrated with an LCD panel of an LCD device. The touch panel is electrically connected to the LCD device and a corresponding control circuit by a flexible printed circuit (FPC), and thereby obtains its touch-control function.

As indicated above, a typical touch panel integrated LCD device is obtained from the LCD panel and the touch panel which are initially individually fabricated. After such fabrication, the separate touch panel is attached to the LCD panel by an adhesive material. Typically, the weight and thickness of the touch-panel integrated LCD device is considerably more than the weight and thickness of the LCD panel alone. That is, the addition of the touch panel and adhesive material to the LCD panel substantially contributes to the total weight of the touch panel integrated LCD device thus obtained. Furthermore, the touch panel and the adhesive material possess optical characteristics which can lead to undesirable effects such as absorption, refraction and reflection. As a result, the touch panel integrated LCD device may suffer from inferior image presentation due to factors such as lower transmittance and optical disturbance.

Therefore, a thinner and lighter touch-sensitive LCD device having superior image presentation is needed.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a schematic, abbreviated diagram of circuit construction of a touch-sensitive LCD device provided by a first embodiment of the present invention, the touch-sensitive LCD device including a plurality of pixel units.

FIG. 2 is an enlarged top plan view of one pixel unit of the touch-sensitive LCD of FIG. 1.

FIG. 3 is a cross-sectional view taken along abbreviated line III-III of FIG. 2.

FIG. 4 is similar to FIG. 3, but showing the touch-sensitive LCD device in an operating condition.

FIG. 5 is an equivalent circuit diagram of certain components illustrated in FIG. 3.

FIG. 6 is a flow chart of an exemplary method for manufacturing the touch-sensitive LCD device of the first embodiment.

FIGS. 7-16 are schematic diagrams illustrating sequential stages in the method of FIG. 6.

FIG. 17 is a plan view of one pixel unit of a touch-sensitive LCD device provided by a second embodiment of the present invention.

FIG. 18 is a cross-sectional view taken along abbreviated line XVIII-XVIII of FIG. 17.

FIG. 19 is a flow chart of an exemplary method for manufacturing the touch-sensitive LCD device of the second embodiment.

FIGS. 20-24 are schematic diagrams illustrating sequential stages in the method of FIG. 19.

FIG. 25 is similar to FIG. 3, but showing a touch-sensitive LCD device that is a modification of the touch-sensitive LCD device of FIG. 3.

### DETAILED DESCRIPTION

Reference will now be made to the drawings to describe various embodiments in detail.

FIG. 1 is a schematic diagram of a circuit construction of a touch-sensitive LCD device provided by a first embodiment of the present disclosure. The touch-sensitive LCD device 100 includes a data driving circuit 101 electrically connected to a plurality of data lines 105 for providing data signals, and a scan driving circuit 102 electrically connected to a plurality of scan lines 106 for providing scan signals. The data lines 105 are parallel to each other, with each data line 105 extending along a first direction. The scan lines 106 are parallel to each other, with each scan line 106 extending along a second direction that is perpendicular to the first direction. Thus, a plurality of pixel units 150 are defined by the crossing data lines 105 and scan lines 106. The touch-sensitive LCD device 100 provided by the present invention further includes a first readout circuit 103 electrically connected to a plurality of first sensing lines 107 for obtaining touch signals from the first sensing lines 107, and a second readout circuit 104 electrically connected to a plurality of second sensing lines 108 for obtaining touch signals from the second sensing lines 107. The first sensing lines 107 are positioned adjacent and parallel to the scan lines 106, and the number of first sensing lines 107 is equal to the number of scan lines 106. The second sensing lines 108 are positioned adjacent and parallel to the data lines 105, and the number of second sensing lines 108 is equal to the number of data lines 107.

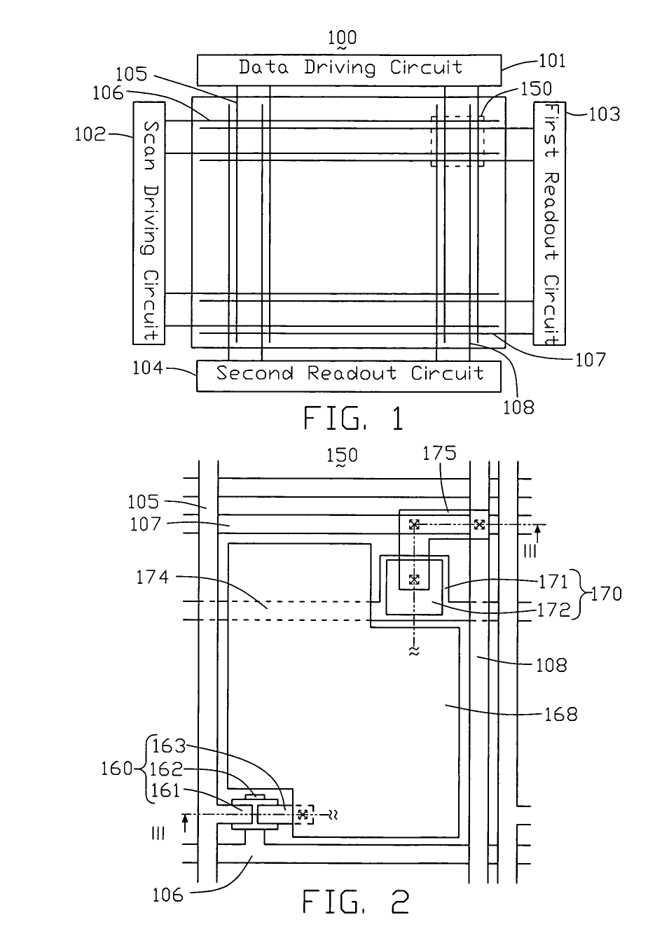

Referring to FIG. 2, this is an enlarged top plan view of one pixel unit 150. The pixel unit 150 includes a thin film transistor (TFT) 160, a pixel electrode 168, a reference capacitor 170, a reference electrode line 174, and a contact plug 175. The TFT 160 is positioned at the intersection of the corresponding data line 105 and the corresponding scan line 106. The TFT 160 includes a source 161, a gate 162, and a drain 163. The source 161 is electrically connected to the data line 105 for receiving the data signals. The gate 162 is electrically connected to the scan line 106 for receiving the scan signals. The drain 162 is electrically connected to the pixel electrode 168 for providing the data signals to the pixel electrode 168.

The reference capacitor 170 is positioned at the intersection of the corresponding first sensing line 107 and the corresponding second sensing line 108. The reference capacitor 170 includes a first electrode 171 and a second electrode 172. The reference electrode line 174 is parallel to the first sensing line 107 and electrically connected to the first electrode 171. The second electrode 172 is formed above the first electrode 171, and is electrically connected to the first and second sensing lines 107, 108 respectively by the contact plug 175.

Referring also to FIG. 3, the touch-sensitive LCD device 100 further includes a first substrate 110, a second substrate 120 parallel and generally opposite to the first substrate 110, and a liquid crystal layer 130 sandwiched between the first substrate 110 and the second substrate 120.

In the exemplary embodiment, the first substrate 110 is a glass substrate. The gate 162 of the TFT 160, the first electrode 171 of the reference capacitor 170, the reference electrode line 174, and the first sensing line 107 are formed on a side of the first substrate 110 that is adjacent to the liquid crystal layer 130. In the exemplary embodiment, a first insulating layer 111 including silicon nitride (SiNx) is formed covering the scan lines 106, the gate 162 of the TFT 160, the first electrode 171 of the reference capacitor 170, the reference electrode line 174, and the first sensing lines 107. The form of silicon nitride can for example be SiNy, SiNz, etc. A semiconductor layer 167 is formed on the first insulating layer 111, corresponding to the gate 162. The semiconductor layer 167 includes a lightly-doped a-Si layer 165 serving as a channel region, and a heavily-doped a-Si layer 166 used to decrease resistance of the lightly-doped a-Si layer 165. The heavily-doped a-Si layer 166 is discontinuous, such that the semiconductor layer 167 can also be considered to be discontinuous. In particular, the semiconductor layer 167 can be considered to have two sides. The source 161 and the drain 163 are formed on the two sides of the semiconductor layer 167, and are generally oriented symmetrically opposite to each other. The second electrode 172 of the reference capacitor 170 is formed on the first insulating layer 111, corresponding to the first electrode 171. The second sensing line 108 is also formed on the first insulating layer 111, simultaneously with the formation of the second electrode 172. A second insulating layer 112 is formed covering the source 161, the semiconductor layer 167, the drain 163, the first insulating layer 111, the second electrode 172, and the second sensing lines 108. In the exemplary embodiment, the second insulating layer 112 includes SiNx, wherein SiNx can for example be SiNy, SiNz, etc. Contact holes 113, 114, 115, 116 are formed in the second insulating layer 112, corresponding to the source 163, the second electrode 172, the first sensing line 107, and the second sensing line 108, respectively. The pixel electrode 168 is disposed on the second insulating layer 112, and is electrically connected to the drain 163 by the contact hole 113. The contact plug 175 is formed over the second electrode 172, and is electrically connected to the first sensing line 107 and the second sensing line 108 respectively through the contact holes 115 and 116.

The second substrate 120 is a flexible transparent substrate, which is able to provide the touch-sensing function by generating a bending deformation when an external pressure is applied. Color filters 121 for displaying red, green and blue colors, and a common electrode 123, are formed at an inner side of the second substrate 120. An overcoat 122 is selectively formed between the common electrode 123 and the color filters 121, in order to planarize the overall structure formed at the inner side of the second substrate 120. The common electrode 123 can, for example, be made of indium tin oxide (ITO) or indium zinc oxide (IZO); and is provided with a common voltage Vcom. It is noteworthy that the touch-sensitive LCD device 100 further includes a columnar first spacer 125 formed above the reference capacitor 170. In the exemplary embodiment, the first spacer 125 is made of an insulating material. As shown in FIG. 3, the first spacer 125 is disposed on the common electrode 123. The first spacer 125 and the reference capacitor 170 are separated by a gap “d”, with the gap “d” being filled with liquid crystal. However, it is not limited that the first spacer 125 can be disposed above the reference capacitor 170 but the first spacer 125 and the common electrode 123 are still separated by the gap (not shown).

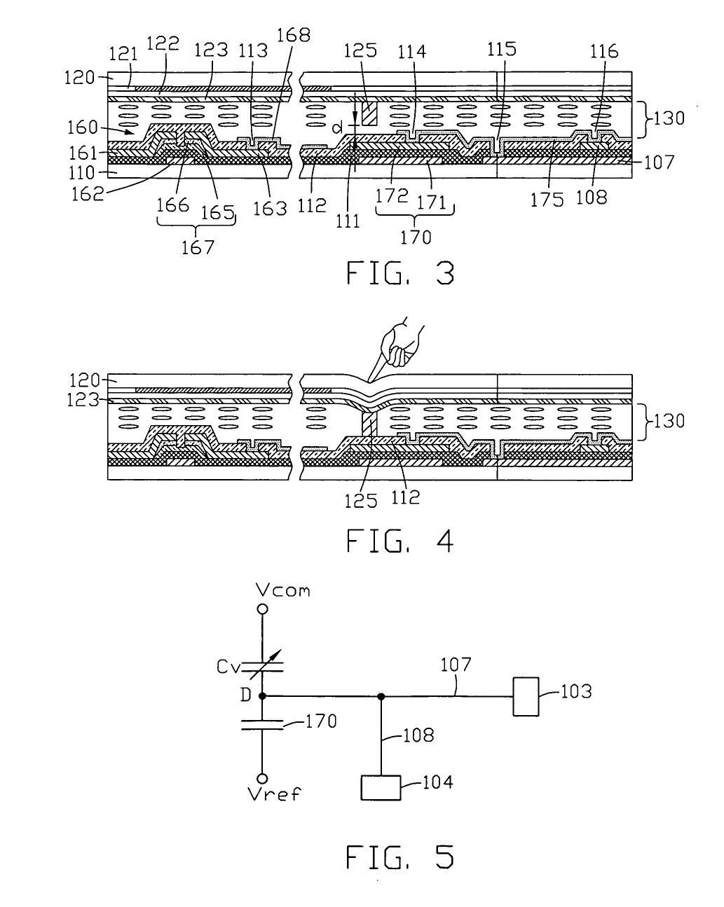

Referring to FIGS. 4-5, since the first spacer 125 and the liquid crystal layer 130 are insulating materials, a spacer capacitor Csp is formed by the common electrode 123, the first spacer 125 and the second electrode 172, and a liquid crystal capacitor Clc is formed by the common electrode 123, the liquid crystal layer 130, and the second electrode 172. The spacer capacitor Csp and the liquid crystal capacitor Clc further cooperatively define (construct) a variable capacitor Cv. In other words, the variable capacitor Cv is defined by the common electrode 123, the first spacer 125, the liquid crystal layer 130, and the second electrode 172. A capacitance of the variable capacitor Cv is a reciprocal of the sum of the capacitances of the spacer capacitor Csp and the liquid crystal capacitor Clc. According to the present invention, the capacitance of the variable capacitor Cv is changeable according to the changes in the magnitude of the gap “d”. When the gap “d” exists (remains open), the capacitance of the variable capacitor Cv is smaller. When the gap “d” is completely closed up to be zero, the capacitance of the variable capacitor Cv is large.

The second electrode 172 involves both in the variable capacitor Cv and the reference capacitor 170, therefore the variable capacitor Cv and the reference capacitor 170 are electrically connected in series by the second electrode 172. And the second electrode 172 further serves as a node electrically connected to the first sensing line 107 and the second sensing line 108, respectively. When a common voltage Vcom and a reference voltage Vref are respectively provided to the common electrode 123 and the first electrode 171, a first voltage Vnl is generated at the second electrode 172. The first voltage Vnl can be expressed according to the following equation:

$$Vn 1 = Vcom + \frac{\frac{1}{Cps} + \frac{1}{Clc}}{\frac{1}{Cps} + \frac{1}{Clc} + \frac{1}{Cref}} ( Vref - Vcom ) \qquad ( 1 )$$

The first voltage Vnl is transmitted to the first readout circuit 103 and the second readout circuit 104 through the first sensing line 107 and the second sensing line 108, respectively.

Referring to FIG. 4, when external pressure provided by a user's finger (for example) is applied on the flexible second substrate 120, a mechanical deflection such as a bending deformation is formed in the second substrate 120, with the first spacer 125 moving down and completely closing up the gap “d”. Therefore a second voltage Vnl′ is generated at the second electrode 172. The second voltage Vnl′ can be expressed according to the following equation:

$$Vn 1 = Vcom + \frac{\frac{1}{Cps} + \frac{1}{Clc}}{\frac{1}{Cps} + \frac{1}{Clc} + \frac{1}{Cref}} ( Vref - Vcom ) \qquad ( 2 )$$

The second voltage Vnl′ is transmitted to the first readout circuit 103 and the second readout circuit 104 respectively through the first sensing line 107 and the second sensing line 108.

Additionally, please refer to FIG. 25, which shows a touch-sensitive LCD device that is a modification of the touch-sensitive LCD device 100. As shown in FIG. 25, the first spacer 125 is formed directly on the overcoat 122 before forming the common electrode 123. Consequently, the common electrode 123 covers the first spacers 125 and the overcoat 122. According to the modification, an insulating layer capacitor Csinx is further formed by the common electrode 123, the second insulating layer 112, and the second electrode 172. Accordingly, the insulating layer capacitor Csinx and the liquid crystal capacitor Clc further cooperatively define (construct) the variable capacitor Cv.

According to the modification, when a common voltage Vcom and a reference voltage Vref are respectively provided to the common electrode 123 and the first electrode 171, a first voltage Vnl is generated at the second electrode 172. The first voltage Vnl can be expressed according to the following equation:

$$Vn 1 = Vcom + \frac{\frac{1}{Clc} + \frac{1}{CSINx}}{\frac{1}{Clc} + \frac{1}{CSINx} + \frac{1}{Cref}} ( Vref - Vcom ) \qquad ( 3 )$$

The first voltage Vnl is transmitted to the first readout circuit 103 and the second readout circuit 104 respectively through the first sensing line 107 and the second sensing line 108, as described above.

When external pressure is applied on the flexible second substrate 120, a mechanical deflection such as a bending deformation is formed in the second substrate 120, with the first spacer 125 moving down and completely closing up the gap “d”. Therefore a second voltage Vnl′ is generated at the second electrode 172. The second voltage Vnl′ can be expressed according to the following equation:

$$Vn {1}^{′} = Vcom + \frac{\frac{1}{CSINx}}{\frac{1}{CSINx} + \frac{1}{Cref}} ( Vref - Vcom ) \qquad ( 4 )$$

The second voltage Vnl′ is transmitted to the first readout circuit 103 and the second readout circuit 104 respectively through the first sensing line 107 and the second sensing line 108, as described above.

According to the difference between the Vnl and Vnl′ that respectively generated before and after touch, the touch action is detected, and a touch signal is generated and transmitted to the first readout circuit 103 and the second readout circuit 104. The touch point is identified as follows. By sequentially scanning the first sensing lines 107, touch signals in Y-directions are detected; and by sequentially scanning the second sensing lines 108, touch signals in X-directions are detected. Thus, the touch point in the two-dimensional X-Y plane is precisely identified.

In another touch-sensitive LCD device that is a variation of the modification shown in FIG. 25, the first spacer 125 can be formed directly on the second substrate 120.

According to the present disclosure, the first sensing line 107, the second sensing line 108, the reference capacitor 170, and the variable capacitor Cv are formed within the touch-sensitive LCD device 100. When the voltage is changed due to a change in the capacitance of the variable capacitor Cv, the touch point is identified. The touch-sensitive LCD device 100 thus has the function of touch-control on its own without the need for a separate touch panel. Consequently, the touch-sensitive LCD device 100 can be thinner, lighter, and more competitive than other comparable touch-control display devices. In addition, since an add-on touch panel and the accompanying adhesive material are absent from the touch-sensitive LCD device 100, their associated adverse optical effects such as absorption, refraction, reflection and interference are correspondingly absent. That is, the touch-sensitive LCD device 100 can have reduced adverse optical effects. Accordingly, signal transmittance and image presentation of the touch-sensitive LCD device 100 can be improved.

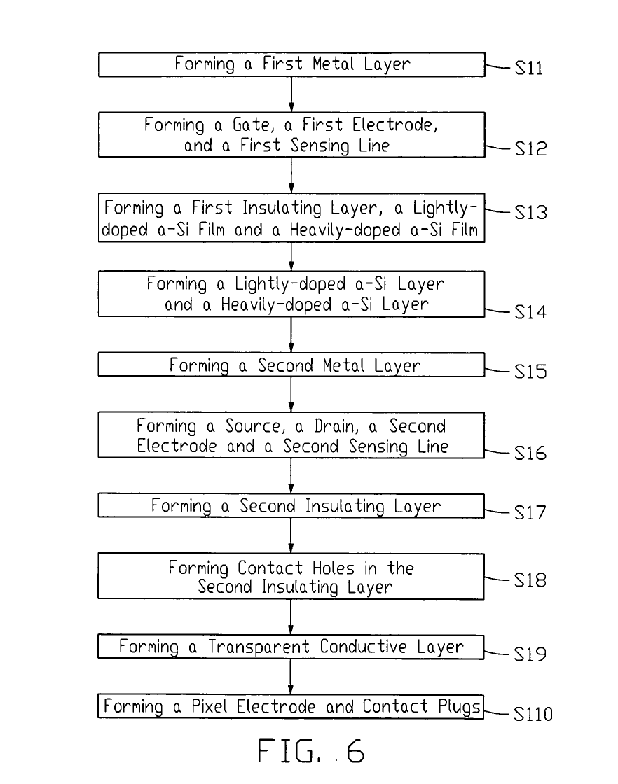

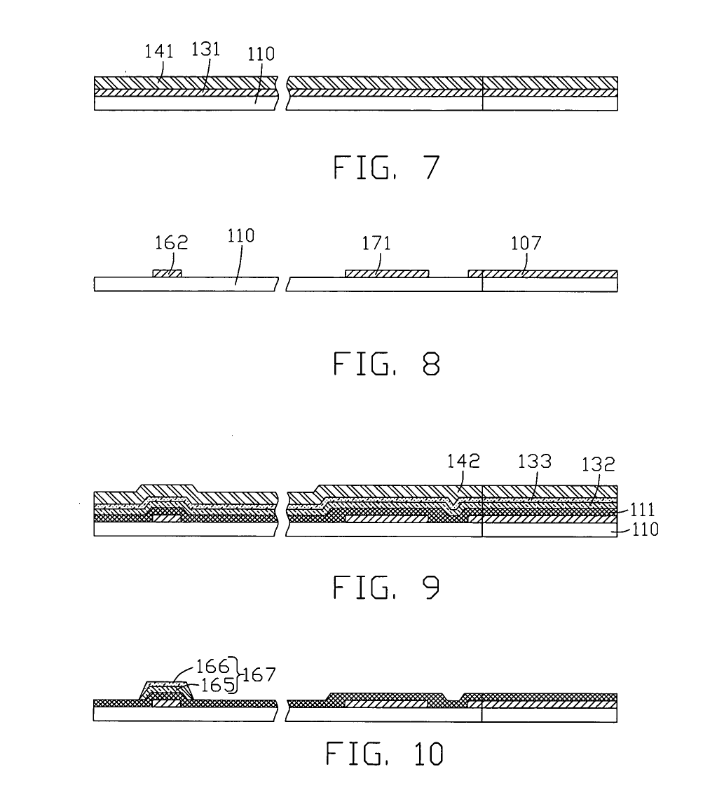

Referring to FIG. 6, this is a flow chart summarizing an exemplary method for manufacturing the touch-sensitive LCD device 100. The method is detailed below with reference to FIGS. 7-16, which are schematic diagrams illustrating sequential stages in the method.

S11: forming a first metal layer:

As shown in FIG. 7, a first substrate 110 such as a glass substrate is firstly provided. A first metal layer 131 and a first photoresist layer 141 are sequentially formed on the first substrate 110. The first metal layer 131 can be a single layer or multi-layer structure. The first metal layer 131 preferably includes aluminum (Al), molybdenum (Mo), chromium (Cr), tantalum (Ta), copper (Cu), or a combination of these metals, is for example formed by physical vapor deposition (PVD). An exemplary thickness of the metal layer is about 300 nm.

S12: forming a gate, a first electrode, and a first sensing line:

As shown in FIG. 8, a first photolithography and etching process (PEP) is performed to form a gate 162, a first electrode 171, a first sensing line 107, and a scan line (not shown). Then the first photoresist layer 141 is removed.

S13: forming a first insulating layer, a lightly-doped a-Si film, and a heavily-doped a-Si film:

As shown in FIG. 9, a first insulating layer 111, a lightly-doped a-Si film 132, a heavily a-Si doped film 133, and a second photoresist layer 142 are sequentially formed on the first substrate 110. The first insulating layer 111 preferably includes SiNx, and is for example formed by chemical vapor deposition (CVD). SiNx can for example be SiNy, SiNz, etc. Next, another CVD is performed to form an a-Si film, and this is followed by ion implantation to form the lightly-doped a-Si film 132 and the heavily-doped a-Si film 133. An exemplary thickness of the first insulating layer 111 is about 300 nm, an exemplary thickness of the lightly-doped a-Si film 132 is about 150 nm, and an exemplary thickness of the heavily doped a-Si film 133 is about 50 nm.

S14: forming a lightly-doped a-Si layer and a heavily-doped a-Si layer:

As shown in FIG. 10, a second PEP is performed to form a semiconductor pattern 167, which includes a lightly-doped a-Si layer 165 and a heavily-doped a-Si layer 166. Then, the second photoresist layer 142 is removed.

S15: forming a second metal layer:

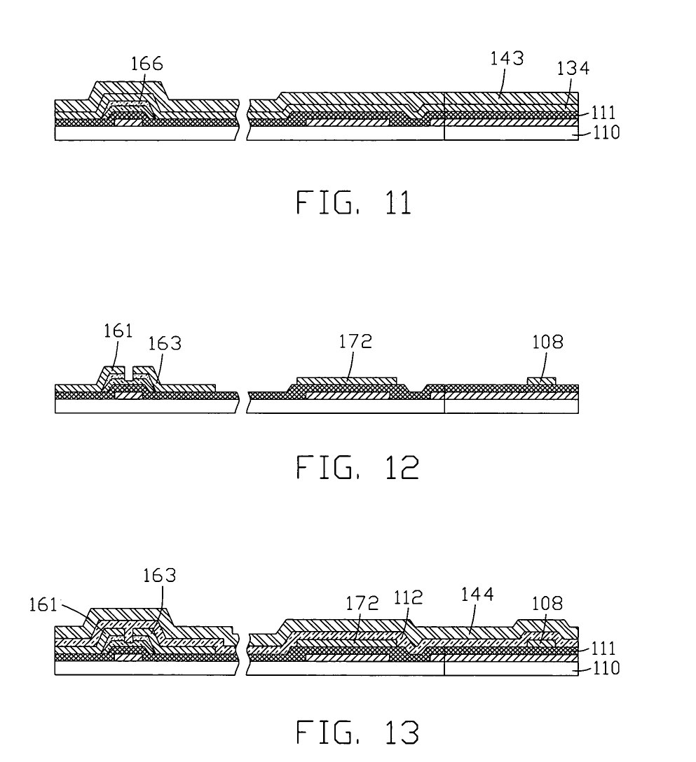

As shown in FIG. 11, a second metal layer 134 and a third photoresist layer 143 are sequentially formed on the first substrate 110. The second metal layer 134 includes Mo alloy or Cr, and is for example formed by PVD. An exemplary thickness of the second metal layer 134 is about 200 nm.

S16: forming a source, a drain, a second electrode, and a second line:

As shown in FIG. 12, a third PEP is performed to form a source 161, a drain 163, a second electrode 172, a second sensing line 108, and a data line (not shown). It is noteworthy that the patterned third photoresist layer 143 serves as another mask for dry etching the heavily-doped a-Si layer 166. The dry etching includes over-etching into the light-doped a-Si layer 165, in order to avoid short circuits occurring in the source/drain 161, 163. Then the third photoresist layer 143 is removed.

S17: forming a second insulating layer:

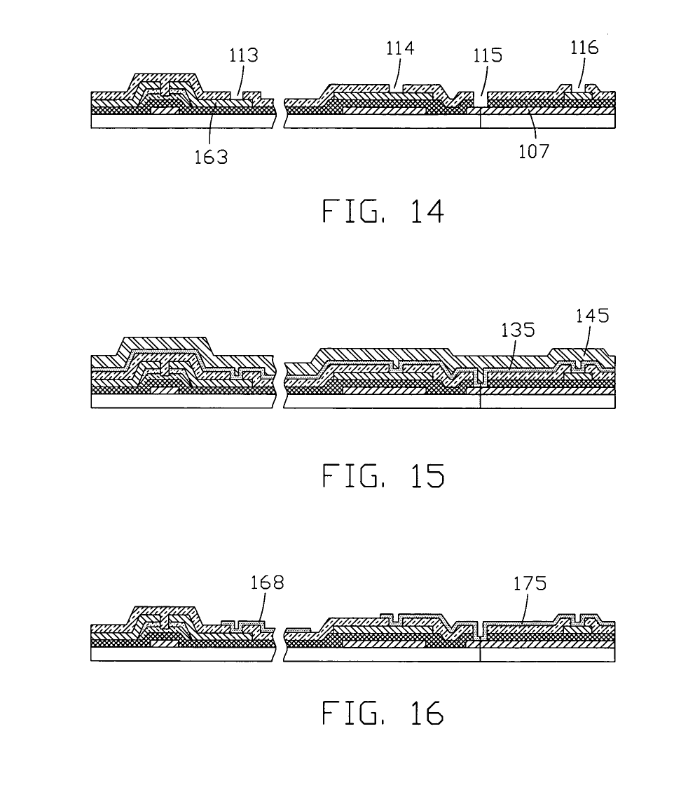

As shown in FIG. 13, a second insulating layer 112 is formed covering the source 161, the drain 163, the first insulating layer 111, the second electrode 172, and the second sensing lines 108 on the first substrate 110. The second insulating layer 112 serves as a back passivation layer. A fourth photoresist layer 144 is sequentially formed on the second insulating layer 112. The second insulating layer 112 preferably includes SiNx, and is for example formed by CVD. SiNx can for example be SiNy, SiNz, etc. An exemplary thickness of the second insulating layer 112 is about 200 nm.

S18: forming a plurality of contact holes in the second insulating layer:

As shown in FIG. 14, a fourth PEP is performed to form a plurality of contact holes 113, 114, 115, 116 in the second insulating layer 112 to respectively expose the drain 163, the second electrode 172, a portion of the first sensing lines 107, and a portion of the second sensing lines 108. Then the fourth photoresist layer 144 is removed.

S19: forming a transparent conductive layer:

As shown in FIG. 15, a transparent conductive layer 135 and a fifth photoresist layer 145 are sequentially formed on the first substrate 110. The transparent conductive layer 135 preferably includes ITO or IZO, and is for example formed by PVD. An exemplary thickness of the transparent conductive layer 135 is about 50 nm.

S110: forming a pixel electrode and a contact plug:

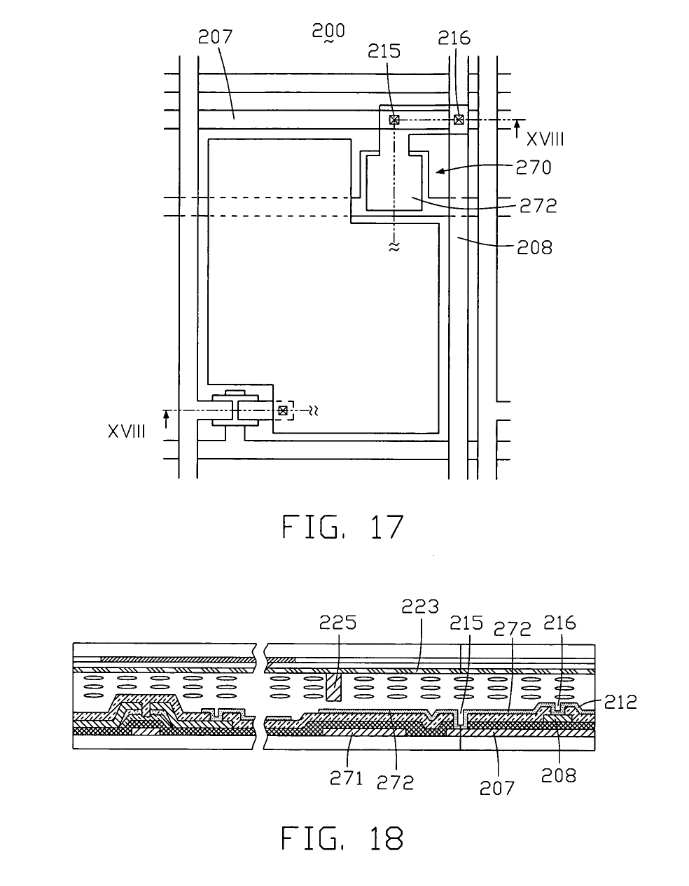

As shown in FIG. 16, a fifth PEP is performed to form a pixel electrode 168 and a contact plug 175. The pixel electrode 168 is electrically connected to the drain 163 of the TFT 160 through the contact holes 113 while the second electrode 172 of the reference capacitor 170 is electrically connected to the first sensing line 107 and the second sensing line 108 by the contact plug 175. Then the fifth photoresist layer 145 is removed.

As described above, the method is able to integrate the reference capacitor 170, the first sensing lines 107 and the second sensing lines 108 in the first substrate 110. Thus, the touch-sensitive LCD device 100 can obtain its touch detecting function with the required elements fabricated within according to the method described.

Referring to FIGS. 17-18, aspects of a touch-sensitive LCD device 200 provided by a second embodiment of the present invention are shown. The touch-sensitive LCD device 200 is similar to the touch-sensitive LCD device 100. Where elements of the touch-sensitive LCD device 200 are the same as or similar to those of the touch-sensitive LCD device 100, a detailed description of such elements is omitted from this specification in the interest of brevity. Referring to FIG. 17, differences between the touch-sensitive LCD device 100 and the touch-sensitive LCD device 200 include the following. A second electrode 272 of a reference capacitor 270 is formed corresponding to a first electrode 271 on a second insulating layer 212, and the second electrode 272 has a protrusion portion (not shown). The second electrode 272 is electrically connected to a first sensing line 207 and a second sensing line 208 by the protrusion portion and contact holes 215, 216 respectively corresponding to the first sensing line 207 and the second sensing line 208.

Accordingly, fewer contact holes/plugs are needed because the second electrode 272 and the first sensing line 207 and the second sensing line 208 are electrically connected by the protrusion. Thus, the reliability of the touch-sensitive LCD device 200 can be further improved.

Referring also to FIG. 18, the touch-sensitive LCD device 200 further includes a spacer capacitor Csp formed by a common electrode 223, a first spacer 225 and the second electrode 272; and a liquid crystal capacitor Clc formed by the common electrode 223, the liquid crystal layer and the second electrode 272. The spacer capacitor Csp and the liquid crystal capacitor Clc cooperatively define (construct) a variable capacitor. Since the mechanism and operation of the touch-sensitive LCD device 200 are substantially the same as those described above in relation to the touch sensitive LCD device 100, details thereof are also omitted from this specification.

In addition, in a modification of the touch sensitive LCD device 200, the first spacer 225 is formed on an overcoat (not labeled) or on a second substrate (not labeled) and is covered by the common electrode 223. These modifications are similar to the modifications described above in relation to the touch-sensitive LCD device 100. The mechanisms and operation of the modifications of the touch-sensitive LCD device 200 are believed to be conceivable and understood to those skilled in the art. Accordingly, details of such the mechanisms and operation are therefore omitted from this specification.

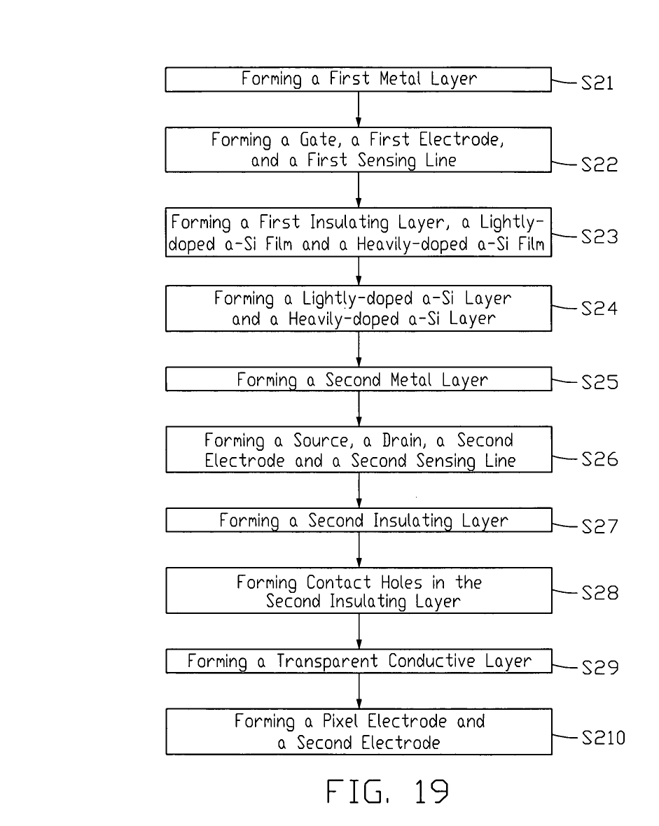

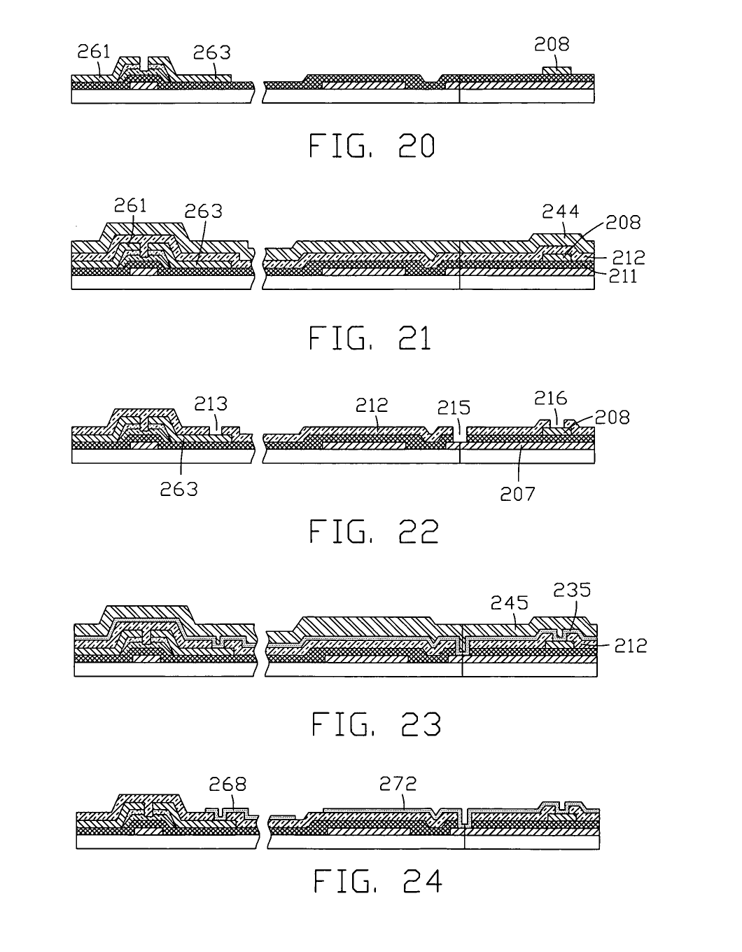

Referring to FIG. 19, this is a flow chart summarizing an exemplary method for manufacturing the touch-sensitive LCD device 200. The method is detailed below with references to FIGS. 20-24, which are schematic diagrams illustrating sequential stages in the method. Those skilled in the art would appreciate that the materials, thicknesses of layers, and processes for forming the layers described in steps S21-S25 of flow chart are similar with those described above in relation to the exemplary method for manufacturing the touch-sensitive LCD device 100. Therefore, details relating to S21-S25 are omitted from this specification, and details relating to S26-S210 are as follows:

S26: forming a source, a drain, a second electrode, and a second line:

As shown in FIG. 20, a TFT including the gate, the first insulating layer 211 serving as a gate insulator and the source/drain 261, 263 is obtained after performing three PEPs. It is noteworthy that the gate, the first electrode 271 of the reference capacitor, the first sensing line 207 and scan lines (not shown) are simultaneously formed while the source 261, the drain 263, the second sensing line 208 and data lines (not shown) are simultaneously formed.

S27: forming a second insulating layer:

As shown in FIG. 21, a second insulating layer 212 and a fourth photoresist layer 244 are sequentially formed on the first substrate. The second insulating layer 212 preferably includes SiNx, and is formed by CVD. SiNx can for example be SiNy, SiNz, etc. The second insulating layer 212 covers the source 261, the drain 263, the first insulating layer 211, and the second sensing line 208.

S28: forming a plurality of contact holes in the second insulating layer:

As shown in FIG. 22, a fourth PEP is performed to form contact holes 213, 215 and 216 penetrating the second insulating layer 112. The drain 263, a portion of the first sensing line 207, and a portion of the second sensing line 208 are therefore exposed. Then the fourth photoresist layer 244 is removed.

S29: forming a transparent conductive layer:

As shown in FIG. 23, a transparent conductive layer 235 preferably including ITO or IZO and a fifth photoresist layer 245 are sequentially formed on the first substrate.

S210: forming a pixel electrode and a second electrode:

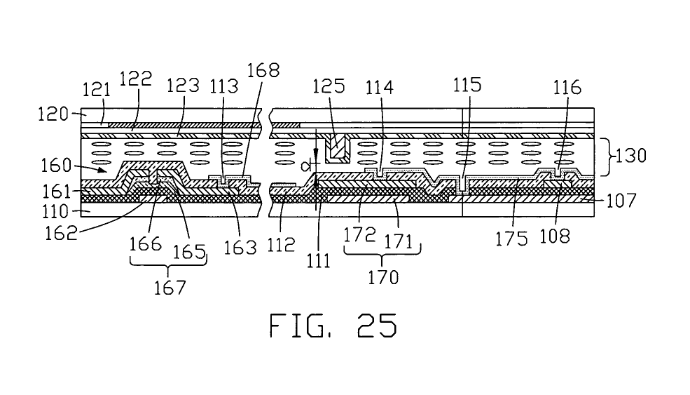

As shown in FIG. 24, a fifth PEP is performed to form a pixel electrode 268 and a second electrode 272 of the reference capacitor 270. The pixel electrode 268 is electrically connected to the drain 263 of the TFT 260 through the contact hole 213, while second electrode 272 is electrically connected to the first sensing line 207 and the second sensing line 208 by the protrusion portion. Then, the fifth photoresist is removed.

In the touch-sensitive LCD device 100, the first electrode 171 and the second electrode 172 of the reference capacitor 170 are separated only by the first insulating layer 111. In contrast, in the touch-sensitive LCD device 200, the first electrode 271 and the second electrode 272 of the reference capacitor 270 are separated by both of the first insulating layer 211 and the second insulating layer 212. Therefore the distance between the two electrodes 171, 172 of the reference capacitor 170 is less than that between the two electrode 271, 272 of the reference capacitor 270. Accordingly, the reference capacitor 170 possesses larger capacitance than the reference capacitor 270. When higher sensitivity is required, the reference capacitor 170 provided by the touch-sensitive LCD device 100 is preferred due to its larger capacitance. Additionally, larger capacitance can be achieved by adjusting the reference voltage applied to the first electrode 171/271.

The first spacers 125/225, which preferably include photo spacers, are respectively formed corresponding to the reference capacitor 170/270. Thus, the first spacers 125/225 avoid adversely affecting the aperture ratio of the touch-sensitive LCD device 100/200, and associated problems of diminution brightness can correspondingly be avoided. Those skilled in art would appreciate that the touch-sensitive LCD device 100/200 can further comprise a plurality of second spacers (not shown) formed in between the first substrate and the second substrate. Different from the first spacers 125/225, the second spacers serve to support a cell gap, thereby helping ensure that the thickness of the touch-sensitive LCD device 100/120 is uniform.

It is to be understood that even though numerous characteristics and advantages of the present embodiments have been set forth in the foregoing description, with details of the structures and functions of the embodiments, the disclosure is illustrative only; and that changes may be in detail, especially in matters of shape, size, and arrangement of parts, within the principles of the embodiments, to the full extent indicated by the broad general meaning of the terms in which the appended claims are expressed.

What is claimed is:

1. A touch-sensitive liquid crystal display (LCD) device comprising:
a first substrate;
a second substrate generally opposite to the first substrate;
a liquid crystal layer sandwiched between the first substrate and the second substrate;
a first sensing line and a second sensing line formed at an inner side of the first substrate on a side adjacent to the liquid crystal layer; and
a reference capacitor and a variable capacitor formed at the inner side of the first substrate, the reference capacitor and the variable capacitor electrically connected in series;
wherein a node between the reference capacitor and the variable capacitor is coupled to the first sensing line and the second sensing line, and a capacitance of the variable capacitor is changeable depending on an external pressure applied on the first substrate.

2. The touch-sensitive LCD device of claim 1, wherein the reference capacitor comprises a first electrode, a second electrode and an insulating layer sandwiched between the first electrode and the second electrode.

3. The touch-sensitive LCD device of claim 2, wherein the variable capacitor comprises a common electrode disposed on the first substrate on a side adjacent to the liquid crystal layer, the second electrode and the liquid crystal layer sandwiched between the common electrode and the second electrode.

4. The touch-sensitive LCD device of claim 3, further comprising a reference electrode line electrically connected to the first electrode on the first substrate.

5. The touch-sensitive LCD device of claim 3, wherein the second electrode is electrically connected to the first sensing line and the second sensing line.

6. The touch-sensitive LCD device of claim 3, further comprising a contact plug electrically connecting the second electrode to the first sensing line and the second sensing line.

7. The touch-sensitive LCD device of claim 3, wherein the capacitance of the variable capacitor is changeable according to a change to a thickness of the liquid crystal layer.

8. The touch-sensitive LCD device of claim 3, further comprising a spacer positioned between the common electrode and the second electrode, and a thickness of the spacer is smaller than a gap between the common electrode and the second electrode.

9. The touch-sensitive LCD device of claim 8, wherein the spacer is disposed on one of the common electrode and the second electrode.

10. The touch-sensitive LCD device of claim 3, further comprising a spacer disposed on the second substrate and covered by the common electrode, and a thickness of the spacer is smaller than a gap between the common electrode and the second electrode.

11. The touch-sensitive LCD device of claim 1, wherein the first substrate further comprises a thin film transistor (TFT), a pixel electrode, a scan line parallel to the first sensing line, and a data line parallel to the second sensing line formed thereon, the TFT comprising a gate electrically connected to the scan line, a source electrically connected to the data line, and a drain electrically connected to the pixel electrode.

12. The touch-sensitive LCD device of claim 1, further comprising a first readout circuit electrically connected to the first sensing line and a second readout circuit electrically connected to the second sensing line.

13. A touch-sensitive LCD device comprising:
a common electrode;
a first sensing line;
a second sensing line perpendicular to the first sensing line;
a reference capacitor corresponding to the common electrode, the reference capacitor comprising a first electrode and a second electrode, the second electrode being positioned between the first electrode and the common electrode; and
a liquid crystal layer sandwiched between the common electrode and the reference capacitor;
wherein when a distance between the common electrode and second electrode is changed, a touch signal is transmitted to the first sensing line and the second sensing line by the second electrode.

14. The touch-sensitive LCD device of claim 13, wherein the common electrode, the second electrode and the liquid crystal layer sandwiched therebetween define a variable capacitor, and a capacitance of the variable capacitor is changeable according to a change to a thickness of the liquid crystal layer.

15. The touch-sensitive LCD device of claim 13, further comprising a contact plug electrically connecting the second electrode to the first sensing line and the second sensing line.

16. The touch-sensitive LCD device of claim 13, further comprising a spacer positioned between the common electrode and the second electrode, a height of the spacer is smaller than a distance between the common electrode and the second electrode.

17. The touch-sensitive LCD device of claim 13, further comprising a spacer covered by the common electrode, and a thickness of the spacer is smaller than a gap between the common electrode and the second electrode.

18. The touch-sensitive LCD device of claim 13, further comprising a first substrate and a second substrate opposite to the first substrate.

19. The touch-sensitive LCD device of claim 18, wherein the first substrate further comprises a TFT, a pixel electrode, a scan line parallel to the first sensing line, and a data line parallel to the second sensing line formed on the first electrode formed thereon, the TFT comprising a gate electrically connected to the scan line, a source electrically connected to the data line, and a drain electrically connected to the pixel electrode.

20. The touch-sensitive LCD device of claim 13, further comprising a first readout circuit electrically connected to the first sensing line and a second readout circuit electrically connected to the second sensing line.
